(19) United States
(12) Patent Application Publication
(10) Pub. No.: US 2025/0132714 A1
(43) Pub. Date: Apr. 24, 2025

(54) METHOD FOR CONTROLLING THE MOVEMENT OF A DRIVE AXLE OF A DRIVE UNIT

(71) Applicant: B&R Industrial Automation GmbH, Eggelsberg (AT)

(72) Inventors: Christoph Hutle, Eggelsberg (AT); Helmut Herzog, Eggelsberg (AT); Michael Hauer, Eggelsberg (AT)

(21) Appl. No.: 18/985,698

(22) Filed: Dec. 18, 2024

Related U.S. Application Data
(63) Continuation of application No. PCT/EP2023/073958, filed on Aug. 31, 2023.

(30) Foreign Application Priority Data
Sep. 1, 2022 (AT) A50671/2022

(51) Int. Cl. H02P 25/064; B65G 54/02

(52) U.S. Cl. CPC H02P 25/064; B65G 54/02

(57) ABSTRACT

Disclosed is a method to determine a jerk-limited movement profile without the use of a downstream jerk filter. A movement profile consists of a starting movement profile and a target movement profile, wherein the starting movement profile starts at the starting movement phase and transitions into the target movement profile. The target movement profile is determined with an acceleration profile over a plurality of control time steps, wherein an acceleration change in each control time step maximally corresponds to a predefined maximum jerk, such that the acceleration profile of the target movement profile is provided as a step function. The step function is created while maintaining the predefined movement limits such that the area below the step function corresponds to a speed change between the beginning speed of the beginning movement phase and the target speed of the target movement phase.

### CROSS-REFERENCE TO RELATED APPLICATIONS

The present application is a continuation of, and claims priority to, International Patent Application No. PCT/EP2023/073958, filed on Aug. 31, 2023, and titled “METHOD FOR CONTROLLING THE MOVEMENT OF A DRIVE AXLE OF A DRIVE UNIT”, which claims priority to Austrian Patent Application No. A50671/2022, filed on Sep. 1, 2022, and titled “METHOD FOR CONTROLLING THE MOVEMENT OF A DRIVE AXLE OF A DRIVE UNIT”, which are hereby incorporated by reference in their entirety.

### TECHNICAL FIELD

The present disclosure relates to a method for regulating the movement of a drive axle of a drive, wherein the movement of the drive axle is regulated in predetermined regulation time steps by specifying a movement setpoint value of the movement, due to which a movement phase of the movement of the drive axle results in each regulation time step, wherein a target movement phase in the form of a target position, target velocity, and target acceleration is specified for the movement of the drive axle and the target movement phase is set starting from a starting movement phase in the form of a starting position, starting velocity, and starting acceleration by a movement profile while maintaining predetermined movement limits, and wherein the movement setpoint value from the movement profile is obtained in each regulation time step.

### BACKGROUND

The regulation of a drive axle of a drive occurs in greatly varying applications. A drive axle essentially consists of a drive unit, such as an electric motor, which acts on a moving drive part in order to move the moving drive part translationally or rotationally in a desired manner. A drive axle generally causes a movement in one direction. Of course, multiple drive axles can also be provided in order to move the moving part in multiple directions. Examples for applications in which drive axles occur are cranes, robots, conveyor devices, machine tools, linear drives, etc., wherein this list is of course not restrictive.

Long stator linear motors are often used as flexible conveyor devices in production, processing, and assembly facilities and similar facilities. A long stator linear motor is known to consist substantially of a long stator in the form of a plurality of magnetic field generating units arranged adjacent to one another, such as drive coils or movable magnets, and a plurality of transport units having excitation magnets (such as permanent magnets, electromagnets, or short-circuit windings), which are moved along the long stator in that the magnetic field generating units generate a moving electromagnetic field which interacts with the excitation magnets on the transport units in order to move the transport units. For example, an electric current can be applied to the drive coils in order to generate a moving electromagnetic field. A conveyor section is thus formed by the long stator, along which the transport units can be moved. It is thus possible to regulate each transport unit individually and independently of one another in its movement (position, velocity, acceleration). For this purpose, each magnetic field generating unit is actuated by an associated drive regulator, which can receive specifications for the movement of a transport unit (for example, in the form of setpoint values for positional velocity) from a higher-order facility control unit.

A long stator linear motor can be embodied having one drive axle or having multiple drive axles. In the latter case, these are often also referred to as planar motors. In a planar motor, the magnetic field generating units are arranged in a plane, by which a planar conveyor section is formed, in which a transport unit is movable in two directions. In addition, the transport unit can also be moved, at least within certain limits, normal to the planar conveyor section, which represents a further drive axle. Such long stator linear motors have been known for some time.

All applications of a drive axle share the feature that the movement of the drive axle is regulated. There is therefore a drive regulator which regulates the movement of the drive part moved by the drive axle in a desired manner. A movement setpoint value is to be specified for the drive axle regulation, which the drive axle is supposed to follow.

A target movement phase is often specified for a drive axle, which is to be approached by the moving drive part, for example, a specific target position on a long stator linear motor, which is to be reached by the moved drive part at a specific target velocity and/or target acceleration. A movement phase is understood as the movement status of the moved to drive part of the drive axle at a specific point in time of the movement, thus position, velocity, acceleration. The drive part therefore has to be regulated by specifications of movement setpoint values so that this target movement phase is reached starting from a starting movement phase. It is often required that a target position is approached as exactly as possible and the moved drive part is stationary in the target position, thus velocity and acceleration are zero in the target position.

The movement target values are generally specified in the form of a movement profile of a movement variable, for example, in the form of a velocity profile or a position profile, which the moved drive part is supposed to follow in order to achieve the target movement phase. The respective movement setpoint value to be specified at the current time of the drive regulation is then ascertained from the movement profile for each time of the movement, for example, a specific velocity setpoint value or position setpoint value, which is to be regulated using the drive regulator at the current time. A current movement phase then results at each time due to the drive regulation.

Known movement restrictions are typically also taken into consideration for the creation of a movement profile, for example, a maximum velocity or a maximum acceleration. Limits for the jerk, which is defined as the time derivative of the acceleration, are often also specified for the movement of a drive axle as a movement restriction in order to reduce the mechanical load on the drive axle due to large acceleration changes. So-called jerk filters are often used for this purpose, which limit the acceleration change (thus the jerk). Such jerk filters are often embodied as low-pass filters or as mean value filters. A movement profile, for example, a position profile or a velocity profile, is created here which is then adapted in the jerk filter in order to achieve the jerk limiting. Such jerk filters require a large amount of storage space, however, because many values of preceding movement setpoint values have to be stored for the mean value calculation. Apart from this, a jerk filter is also always dependent on the past, because a jerk filter also processes past values. A dead time of a jerk filter results therefrom, because initially sufficient past values have to be present before the jerk filter operates properly. It also follows therefrom that a movement profile cannot simply be switched over, for example, by specifying a new target movement phase.

Of course, it would also be possible to generate movement profiles which are jerk-limited from the outset. However, generating such movement profiles is very computing intensive. In particular in applications such as a conveyor device in the form of a long stator linear motor, in which there is a plurality of transport units to be moved, the limits of the available computing power are reached rapidly. Therefore, in many applications only simple acceleration-limited movement profiles are generated for a drive axle, which are jerk-limited later in a jerk filter.

Moreover, the problem exists in practice that a drive axle regulation is embodied discreetly, thus a new movement setpoint value is specified in certain predetermined regulation time steps, from which the drive axle regulator calculates a manipulated variable for the drive unit of the drive axle in each regulation time step, using which the drive unit is actuated in order to set the current movement setpoint value. Of course, actual values of the movement are also detected here and supplied to the drive axle regulator, for example, actual positions. The actual values are also typically detected in each regulation time step. A manipulated variable is, for example, an electric current or an electric voltage which are to be set at the drive coils of a long stator linear motor, or an electric current of an electric motor. It is apparent therefrom that the movement setpoint value can change only at the discrete times predetermined by the regulation time step. If the movement setpoint value is a velocity, for example, this would result in a step function of the velocity profile having velocity terms. These velocity jumps because large jump points in the acceleration and therefore a large jerk. It therefore in turn becomes necessary to use a filter in order to eliminate these jump points, which is again connected to the above disadvantages, however.

It would therefore be advantageous to specify the movement setpoint value in a discrete drive regulation of a drive axle so that the jerk is limited and the use of a jerk filter is obsolete, wherein the jerk-limited movement profile is as simple as possible to create.

### BRIEF DESCRIPTION

This object is achieved in that the movement profile consists of a starting movement profile and a target movement profile, wherein the starting movement profile starts at the starting movement phase and merges into the target movement profile, which starts in an initial movement phase and ends in the target movement phase. The starting movement profile is arbitrary in this case and can be presumed to be known or specified. The target movement profile is ascertained using an acceleration profile over a plurality of regulation time steps, wherein an acceleration change in each regulation time step corresponds at most to a specified maximum jerk, so that the acceleration profile of the target movement profile is provided as a step function in which the acceleration profile is a chronologically discrete sequence of acceleration values at the regulation time steps k. The possible acceleration changes therefore between zero and the specified maximum jerk. The step function is created while adhering to the specified movement limits, so that the area below the step function corresponds to a velocity change between the initial velocity of the initial movement phase and the target velocity of the target movement phase. A target distance, which is covered using the target movement profile, is ascertained using the ascertained target movement profile, and a time (a specific regulation time step) is ascertained on the basis of the target distance, at which the ascertained target movement profile is started in order to reach the target position of the target movement phase.

A jerk-limited target movement profile of the movement profile can therefore be created solely analytically in a simple manner. The target movement profile ensures achieving a target movement phase from an initial movement phase while adhering to the jerk limiting.

The target movement profile is advantageously created in that the acceleration is reduced or increased starting from the initial acceleration in a first acceleration section in a plurality of regulation time steps by at most the specified maximum jerk and then the acceleration is increased or reduced in a second acceleration section in a plurality of regulation time steps by at most the specified maximum jerk until the target acceleration is achieved. Alternatively, in that the acceleration is reduced or increased starting from the initial acceleration in a first acceleration section in a plurality of regulation time steps by at most the specified maximum jerk until a specified minimum acceleration or maximum acceleration is achieved, then the acceleration is kept at the minimum acceleration or maximum acceleration in a third acceleration section for a number of regulation time steps and then the acceleration is increased or reduced in a second acceleration section in a plurality of regulation time steps by at most the specified maximum jerk until the target acceleration is achieved. This ensures a simple embodiment of a target movement profile which can be created easily.

If an acceleration change in a regulation time step of the target movement profile corresponds to a specified maximum jerk, if the specified movement limits permit this, so that the area below the step function, except for a residual error, corresponds to the velocity change between the initial velocity of the initial movement phase and the target velocity of the target movement phase, and the acceleration change in at least one regulation time step of the target movement profile is changed by a value of the jerk, wherein the value of the jerk is ascertained in order to compensate for the residual error resulting from the step function between the area below the step function and the velocity change, on the one hand, the fastest possible approach to the target movement phase with a jerk-limited movement is achieved. At the same time, the target velocity is approached exactly.

It is advantageous for the accuracy if a position error resulting from the step function between the target position and a position resulting from the target movement profile is compensated for in that in the acceleration profile the acceleration change is changed at a plurality of regulation time steps in order to lengthen or shorten the target travel by the position error, wherein the area below the acceleration profile remains unchanged.

### DETAILED DESCRIPTION

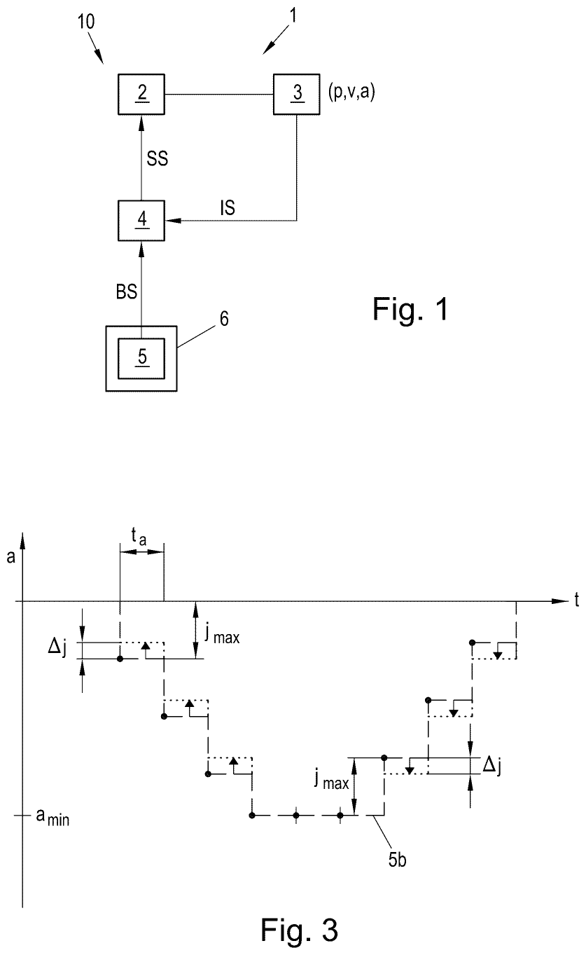

The present disclosure will be explained in more detail hereinafter with reference to FIGS. 1 to 6, which show advantageous embodiments of the disclosure by way of example, schematically, and non-restrictively.

FIG. 1 shows a drive axle having a drive axle regulator.

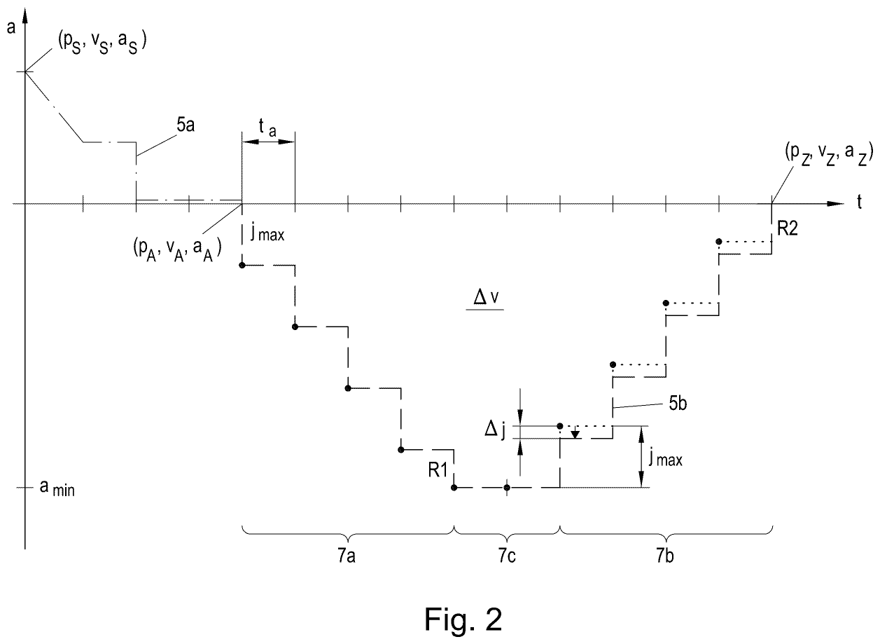

FIG. 2 shows a-limited target movement profile.

FIG. 3 shows a jerk-limited target movement profile with compensation of a position error.

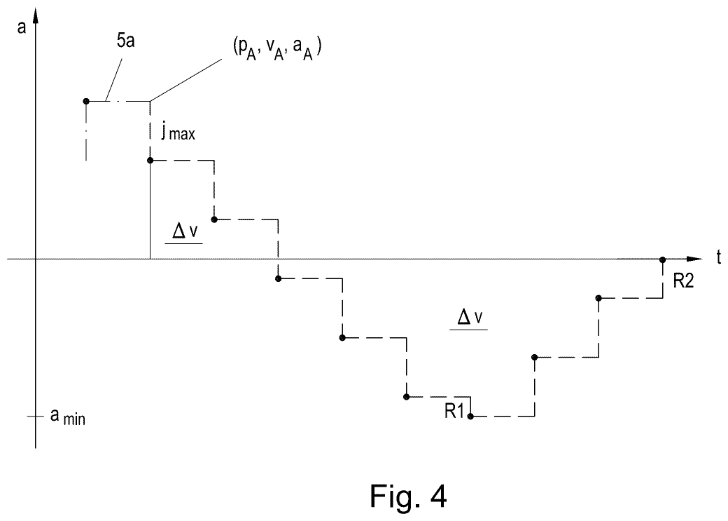

FIG. 4 shows a jerk-limited target movement profile with an initial acceleration not equal to zero.

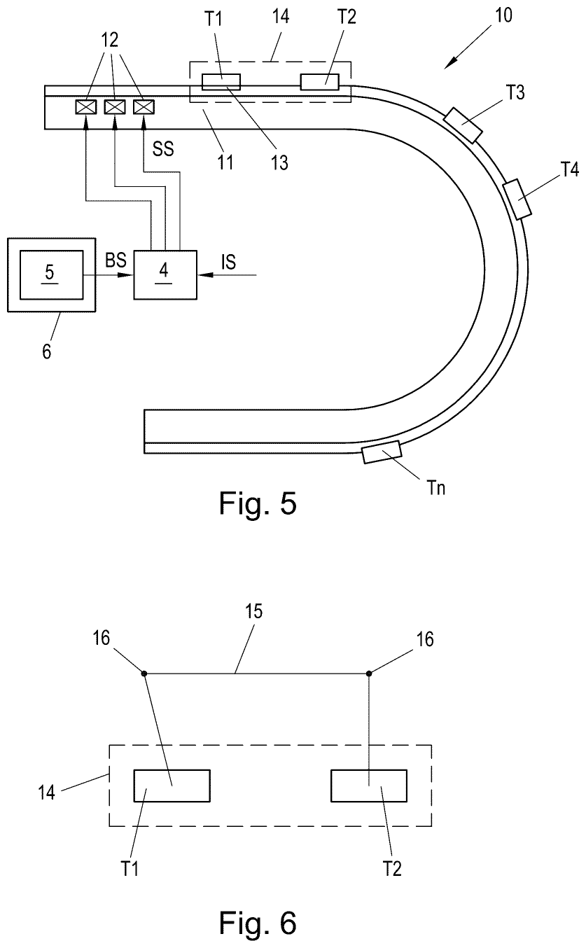

FIG. 5 shows a drive axle in the form of a long stator linear motor.

FIG. 6 shows a transport unit group having coupled transport units.

### DETAILED DESCRIPTION

FIG. 1 shows a drive axle 1 having a drive unit 2, on which a moved drive part 3 acts in order to move it. A movement phase (p, v, a) therefore results on the moved drive part 3, wherein p stands for the position, v stands for the velocity, and a stands for the acceleration. The position can be an angle or a distance. The velocity can therefore be an angular velocity or linear velocity and the acceleration can be an angular acceleration or linear acceleration. The movement phase (p, v, a) is to be regulated by a drive axle regulator 4. The drive axle regulator 4 ascertains a manipulated variable SS, using which the drive unit 2 is actuated in order to set a specified movement setpoint value BS, for example, a target position of the moved drive part 3. The drive axle regulator 4 typically also processes a movement actual value IS, for example, an actual position, which is detected in the drive axle 1, for example, by means of a measuring sensor. This general structure of a drive axle 1 is well known and does not have to be explained in more detail.

It is also conceivable that the moved drive part 3 is part of multiple drive axles 1 and it can therefore be moved in various directions, for example, a transport unit in the case of a planar motor. The drive axle regulator 4 can then regulate the movement of multiple drive axles 1, or one drive axle regulator 4 can be provided for each movement.

In each regulation time step k, wherein a predetermined time interval tₐ is provided between two successive regulation time steps k, k+1, a movement profile BSᵢ is specified, and possibly a movement actual value ISᵢ is detected, from which the drive axle regulator 4 ascertains a manipulated variable SSᵢ. The drive unit 2 is actuated using this manipulated variable SSᵢ and therefore acts on the moved drive part 3, so that a new movement actual value ISᵢ₊₁ results. This is cyclically repeated until the target movement phase is reached.

The time interval tₐ is typically in the range of 100 μs to 100 ms, typically in the millisecond range.

The drive axle regulator 4 is typically microprocessor-based hardware, on which regulation software is executed. The drive axle regulator 4 can also be implemented, however, as a field programmable gate array (FPGA) or application-specific integrated circuit (ASIC).

The movement setpoint value BSᵢ for each regulation time step k is provided by a movement profile 5 of a movement variable of the movement phase, for example, position, velocity, or acceleration. The movement profile 5 is essentially a sequence of values of the movement variable for each regulation time step k. The movement profile 5 is, for example, a position profile having the position as a movement variable or a velocity profile having the velocity as a movement variable. The movement profile 5 is used to transfer a specified starting movement phase (pₛ, vₛ, aₛ) of the moved drive part 3 by a specific movement into a desired target movement phase (p_{z}, v_{z}, a_{z}). For each regulation time step during this movement, a movement phase (position, velocity, acceleration) of the moved drive part 3 thus results. The target velocity v_{z} and the target acceleration a_{z} are often equal to zero, by which a specific target position p_{z} is approached, at which the moved drive part 3 is supposed to be stationary. Of course, however, it is also possible to provide a target velocity v_{z} and/or target acceleration a_{z} not equal to zero. The movement profile 5 has to be known for the regulation of the movement of the drive axle 1, specifically of the moved drive part 3 of the drive axle 1.

Certain boundary conditions are also to be adhered to in the planning of the movement profile 5, in particular specified movement limits of a movement variable. Typically, maximum possible positive and negative acceleration aₘₐₓ, aₘᵢₙ and a maximum possible positive velocity vₘₐₓ, possibly also a minimum positive/negative velocity and/or a negative maximum velocity −vₘₐₓ, of the moved drive part 3 are provided as movement limits. Such movement limits can also result from physical restrictions of the drive axle 1 or also from an application of the drive axle 1, but are known in any case. In order to be able to dispense with a jerk filter connected downstream, as a further movement limit, in any case the jerk j (as the time derivative of the acceleration) in both directions, thus for positive and negative accelerations, is limited by a specified maximum jerk ±jₘₐₓ. It is to be noted that jₘₐₓ is used both for the positive and the negative permitted jerk, wherein the value for the positive and negative permitted jerk jₘₐₓ does not necessarily have to be equal. The acceleration change between two successive regulation time steps k, k+1 is therefore limited by the maximum jerk jₘₐₓ and cannot be greater than the maximum jerk jₘₐₓ.

A positive acceleration is understood as an acceleration which increases the velocity of the moved drive part 3 and a negative acceleration is understood as an acceleration which reduces the velocity of the moved drive part 3. In the event of a sign change of the velocity (thus when the direction of the movement is changed), this is inverted, of course.

The present disclosure presumes that an arbitrary starting movement phase (pₛ, vₛ, aₛ) of the drive axle 1 exists, which is to be transferred using a movement profile 5 by the drive axle regulator 4 into a specified target movement phase (p_{z}, v_{z}, a_{z}).

Due to the movement limits, however, the target movement phase (p_{z}, v_{z}, a_{z}) cannot be reached from any arbitrary movement phase resulting between the starting movement phase (pₛ, vₛ, aₛ) and target movement phase (p_{z}, v_{z}, a_{z}). A target movement profile 5b is therefore ascertained, using which it is ensured that the target movement phase (p_{z}, v_{z}, a_{z}) is reached starting from an initial movement phase (p_{A}, v_{A}, a_{A}) between the starting movement phase (pₛ, vₛ, aₛ) and target movement phase (p_{z}, v_{z}, a_{z}). The movement profile 5 therefore consists of a starting movement profile 5a, which is adjoined by the target movement profile 5b. The starting movement profile 5a can be arbitrary and can be assumed to be specified. This is shown by way of example in FIG. 2.

Due to the discrete implementation, the acceleration value a can only change in each regulation time step k (at specified time intervals tₐ) of the movement profile 5. The acceleration profile is selected for the movement planning because the jerk j can thus be restricted in a simple manner. The acceleration change between two successive regulation time steps k, k+1 can at most be a specified maximum jerk jₘₐₓ, by which the jerk limiting is already implemented. A step function having acceleration values at each regulation time step k therefore results for the acceleration profile. The acceleration profile is a chronologically discrete sequence of acceleration values at the regulation time steps k, wherein the acceleration change between two successive regulation time steps k, k+1 is at most a specified maximum jerk jₘₐₓ.

It is to be clarified for comprehension that the movement profile 5 for the regulation of the movement is ascertained using an acceleration profile. A velocity profile (discrete sequence of velocity values in each regulation time step k) results from the acceleration profile by time integration and a position profile (discrete sequence of position values in each regulation time step k) results by integration twice. The movement variable of the movement profile 5 can therefore be position, velocity, or acceleration. In the described exemplary embodiment, the acceleration profile is used as the movement profile 5 only for the sake of simplicity.

FIG. 2 shows the movement profile 5 having an arbitrary known starting movement profile 5a (dot-dash line, wherein the starting movement phase (pₛ, vₛ, aₛ) is indicated) and a target movement profile 5b. The target movement phase (p_{z}, v_{z}, a_{z}) is given in this exemplary embodiment by a target position p_{z}, in which the target velocity v_{z} and the target acceleration a_{z} are to be zero. The target movement profile 5b in this example describes a deceleration of the moved drive part 3 (thus negative accelerations), wherein the target movement profile 5b can likewise comprise positive accelerations, however. In some embodiments, the target movement profile 5b is executed to achieve the target movement phase (p_{z}, v_{z}, a_{z}) as quickly as possible starting from an initial movement phase (p_{A}, v_{A}, a_{A}), so that the target movement profile 5b can therefore be started as late as possible. This requires, for example, that the acceleration changes in the target movement profile 5b are to correspond as much as possible to the maximum jerk jₘₐₓ. However, the target movement profile 5b can also correspond to other specifications, for example, other movement limits, acceleration change only each nth (n>1) regulation time step k, etc.

Using the target movement profile 5b, the initial position p_{A} is to be changed to the target position p_{z}, the initial velocity v_{A} is to be changed to the target velocity v_{z}, and the initial acceleration ax is to be changed to the target acceleration a_{z}—the target movement phase (p_{z}, v_{z}, a_{z}) is thus to result upon execution of the target movement profile 5b using the drive axle regulator 4. Because the starting movement phase (p_{A}, v_{A}, a_{A}) and also the starting movement profile 5a can be arbitrary, however, and the specified movement limits have to be adhered to, the target movement profile 5b has to be ascertained in order to transfer the initial movement phase (p_{A}, v_{A}, a_{A}) to the target movement phase (p_{z}, v_{z}, a_{z}).

For the explanation of the ascertainment of the target movement profile 5b, it is presumed for simplification that before the target movement profile 5b, the moved drive part 3 is moved with a constant positive initial velocity v_{A} not equal to zero, the initial acceleration ax is therefore equal to zero.

FIG. 2 shows the acceleration profile of the target movement profile 5b. The velocity and position curves resulting therefrom are known to result as the time and the girls of the acceleration profile and are not shown in FIG. 2.

In the exemplary embodiment described, the current, known initial velocity v_{A} is to be reduced to the target velocity v_{z}=0 and at the same time the target position p_{z} is to be reached. The velocity of the moved drive part 3 is therefore to be changed by acceleration specifications in a number of regulation time steps k to the target velocity v_{z}, wherein in each regulation time step k, the acceleration change can correspond at most to the specified maximum jerk jₘₐₓ, in order to adhere to the jerk limit. In the exemplary embodiment shown, the moved drive part 3 is to be decelerated first, which takes place in a number of regulation time steps k. The acceleration a therefore decreases in each regulation time step k, wherein the acceleration change in each regulation time step k corresponds at most to the specified maximum jerk jₘₐₓ until the specified minimum acceleration aₘᵢₙ is reached.

From a specific time (regulation time step k), the acceleration has to be increased again in order to reach the target acceleration a_{z}=0 again in a number of regulation time steps k in consideration of the jerk limit. The acceleration cannot be less than the minimum acceleration aₘᵢₙ, due to which there can be a number of regulation time steps k in which further deceleration takes place at the minimum acceleration aₘᵢₙ (as in FIG. 2). It can therefore also be the case that the minimum acceleration aₘᵢₙ is not reached at all. A maximum possible (thus shortest chronologically possible) deceleration of the moved drive part 3 is therefore achieved while adhering to the jerk limit.

In general, this means that in the acceleration profile of the target movement profile 5b, the acceleration a is reduced or increased starting from the initial acceleration a in a first acceleration section 7a in a plurality of regulation time steps k, wherein the acceleration change corresponds at most to the specified maximum jerk jₘₐₓ. In a following second acceleration section 7b, the acceleration a is increased or reduced in a plurality of regulation time steps k, wherein the acceleration change corresponds at most to the specified maximum jerk jₘₐₓ until the target acceleration a_{z} is reached. In this case, a triangular step function would result as the acceleration profile. However, a third acceleration section 7c can result between the first acceleration section 7a and the second acceleration section 7b, in which the specified minimum acceleration aₘᵢₙ or maximum acceleration aₘₐₓ is reached and this is maintained for a number of regulation time steps k. In this case, a trapezoidal step function results as the acceleration profile.

Due to the acceleration limit aₘᵢₙ, aₘₐₓ at the regulation time steps k and the specified maximum jerk jₘₐₓ, of course, it can be the case that residual steps R1, R2 in the step function of the acceleration profile are not to be implemented with the maximum possible acceleration change (maximum jerk jₘₐₓ), as shown in FIG. 2. These residual steps that are R1, R2 are easy to ascertain, however.

For example, the number i of the regulation time steps k in order to arrive at the specified minimum acceleration aₘᵢₙ from the initial acceleration a_{A} with application of the specified maximum jerk jₘₐₓ is given by

$$i = ⌊ \frac{\vert {a}_{min} \vert}{{j}_{max} \cdot {t}_{a}} ⌋ .$$

The residual step R1 thus results as

$$R 1 = \frac{\vert {a}_{min} \vert}{{t}_{a}} - i \cdot {j}_{max} .$$

The residual step R2 can be ascertained analogously.

The number i of the regulation time steps k in the first acceleration section 7a and in the second acceleration section 7b can thus be ascertained easily.

The area under the acceleration profile is known to correspond to the velocity. For the target movement profile 5b, the area under the acceleration profile corresponds to the velocity change Δv from the initial velocity v_{A} to the target velocity v_{z}, in the described exemplary embodiment according to FIG. 2 thus the achieved velocity reduction. The area under the acceleration profile therefore has to correspond to the velocity change Δv so that the specified target velocity v_{z} is reached. One therefore has a first criterion for the planning of the target movement profile 5b to reach the target velocity v_{z}.

The calculation of the area under the step function of the acceleration profile is trivial. The area can primarily be influenced in that the number of the regulation time steps k having minimum acceleration aₘᵢₙ or maximum acceleration aₘₐₓ (third acceleration section 7c) is changed. The more regulation time steps k having minimum acceleration aₘᵢₙ or maximum acceleration aₘₐₓ, the greater the area becomes and therefore the greater the velocity change Δv achieved using the target movement profile 5b becomes. If the minimum acceleration aₘᵢₙ is not reached, the area can be easily influenced by the number of the steps having the maximum jerk jₘₐₓ. The area can also be influenced by selection of the acceleration changes in a number of regulation time steps k. In principle, the acceleration change can be selected freely between zero and the specified maximum jerk jₘₐₓ.

Due to the discretization of the acceleration a to the regulation time steps k, however, it can also be the case that the resulting area under the acceleration profile does not exactly correspond to the desired velocity change Δv, but rather a certain error results therefrom and the target velocity v_{z} is not reached exactly. This will occur in particular if all acceleration changes take place with the specified maximum jerk jₘₐₓ. This error results directly as the difference of the ascertained area from the desired velocity change Δv and can therefore be ascertained easily. To compensate for this error, in at least one regulation time step k of the target movement profile 5b, the acceleration change is changed by a value Δj, so that the area under the acceleration profile corresponds to the desired velocity change Δv. In this case, of course, the specified movement limits are to be adhered to, in particular the specified maximum jerk jₘₐₓ and the maximum acceleration aₘᵢₙ or maximum acceleration aₘₐₓ cannot be infringed. The ascertainment of this value Δj can be performed easily because the effects of this value on the area under the acceleration curve can be established immediately.

In FIG. 2, for example, the first acceleration change after the third acceleration section 7c is not carried out with the maximum jerk jₘₐₓ, but rather a value smaller by the value Δj. The remaining acceleration change takes place in this exemplary embodiment with the maximum jerk jₘₐₓ again. The area under the acceleration profile thus becomes greater.

The target movement profile 5b can therefore be ascertained to achieve the desired velocity change Δv from the initial velocity v_{A} to the target velocity v_{z}.

If the maximum jerk jₘₐₓ is used for the ascertainment of the target movement profile 5b, it is then ensured that the velocity change Δv takes place as quickly as possible, thus using as few regulation steps k as possible, while adhering to the movement limits.

However, not only the target velocity v_{z} is to be reached, but also the target position p_{z}. The question then arises when the target movement profile 5b has to be started, for example, as shown in FIG. 2, so that the target position p_{z} has resulted at the end of the target movement profile 5b. For this purpose, with the target movement profile 5b ascertained for reaching the velocity change Δv, in addition the target distance is ascertained which is covered upon execution of the ascertained target movement profile 5b, thus when the moved drive part 3 is moved using the target movement profile 5b. One therefore has a second criterion for the planning of the movement to reach the target position p_{z}.

The ascertainment of the target distance covered using the previously determined target movement profile 5b is also trivial, because the target distance results as the time integral of the velocity profile resulting due to the target movement profile 5b or as the double time integral of the acceleration profile of the target movement profile 5b.

The current position of the moved drive part 3 is thus to be checked. If the current position corresponds to the difference of target position p_{z} and target distance, the target movement profile 5b then has to be initiated so that the desired target position p_{z} results with the target movement profile 5b. The time for starting the target movement profile 5b can thus be established.

Errors are also to be expected here due to the discretization. In particular, the difference of target position p_{z} and target distance will not exactly correspond to a position which the moved drive part 3 assumes in a regulation time step k upon the implementation of the movement profile 5. The target movement profile 5b will therefore be started either somewhat too early or too late and the target position p_{z} will not result exactly. If the requirements for the target position p_{z} are not excessively high, this error can be accepted. However, if the target position p_{z} is to be approached as exactly as possible, then this error can also be compensated for.

The approach here is also again to change the acceleration change by a value Δj in a number of regulation steps k in the acceleration profile of the target movement profile 5b. However, the area under the acceleration profile cannot change in this case in order to reach the target velocity v_{z}. Of course, the specified movement limits are also again to be adhered to, in particular the specified maximum jerk jₘₐₓ and the minimum acceleration aₘᵢₙ or maximum acceleration aₘₐₓ cannot be infringed. This is shown by an example in FIG. 3. The goal is to achieve the same velocity change Δv in the number of the regulation time steps k by way of the value Δj, but with a time change, so that the target position p_{z} is reached exactly and the error is compensated for. The velocity change Δv due to the target movement profile 5b is therefore either lengthened in time or shortened in time, as needed.

The ascertainment of this value Δj can be carried out easily, because the effects of this value on the area under the acceleration curve and on the target distance thus resulting can be established immediately.

FIG. 3 shows an exemplary embodiment of a position correction. In this exemplary embodiment, the acceleration changes are reduced by the value Δj in the first regulation time step k in the first acceleration section 7a. The acceleration change therefore no longer corresponds to the maximum jerk jₘₐₓ. The other acceleration changes again take place with the maximum jerk jₘₐₓ (but could also take place with a smaller acceleration change). The initial velocity v_{A} is therefore reduced more slowly and the target distance lengthens. However, the area below the acceleration profile would thus also be shrunk. To counteract this, in this exemplary embodiment the acceleration changes are also reduced by the value Δj in the first regulation time step k in the second acceleration section 7b in order to compensate for the smaller area. The other acceleration changes I take place with the maximum jerk jₘₐₓ (but could take place with a smaller acceleration change). The initial velocity v_{A} is therefore reduced more slowly and the target distance lengthens. It is immediately apparent that there are a variety of options for engaging in the acceleration changes of the acceleration profile in order to lengthen or shorten the target distance, on the one hand, without changing the area below the acceleration profile at the same time.

As already mentioned, the target movement profile 5b does not necessarily have to begin at an initial movement phase (p_{A} v_{A}, a_{A}) with the initial acceleration a_{A}=0. In general, the initial acceleration as can assume an arbitrary value (within specified movement limits aₘₐₓ, aₘᵢₙ). This is shown by way of example in FIG. 4. However, this changes nothing in the above-explained fundamental procedure.

In this exemplary embodiment, the target movement profile 5b starts with an initial acceleration a_{A}>0 and a known initial velocity v_{A}, which results in the initial movement phase (p_{A}, v_{A}, a_{A}). The target movement profile 5b is ascertained precisely as explained above for FIG. 2. The area under the entire step function beginning from the initial movement phase (p_{A}, v_{A}, a_{A}) is therefore again decisive, which is again to correspond to the velocity change Δv from the initial velocity v_{A} id to the target velocity v_{z}. The target distance can again be ascertained using the target movement profile 5b, by which it can in turn be determined when (or at which regulation time step k), the target movement profile 5b has to start. The above errors in the target velocity v_{z} or in the target velocity v_{z} and the target position p_{z} can also be compensated for immediately.

The target movement profile 5b thus does not necessarily have to reduce the velocity from an initial velocity v_{A} to a target velocity v_{z} (for example 0), but rather it could also be provided that the target movement profile 5b increases the velocity. The target movement profile 5b could therefore also be defined in the range of positive accelerations.

The following procedure could be used in the implementation of the present disclosure. The movement of the drive axle 1 is started from the specified starting movement phase (pₛ, vₛ, aₛ) using a desired or specified starting movement profile 5a. The starting movement profile 5a supplies in each regulation time step k a movement setpoint variable BSₖ for the drive axle regulator 4. In each regulation time step k, the resulting movement phase in the next regulation time step k+1 will be ascertained, for example, in that the movement is continued with the maximum jerk jₘₐₓ or from the starting movement profile 5a, if it is known. The movement phase in the next regulation time step k+1 is used as the initial movement phase (p_{A}, v_{A}, a_{A}) and a target movement profile 5b is ascertained based thereon, using which the velocity change Δv between the initial velocity v_{A} and the target velocity v_{z} is induced. The target distance is ascertained from the ascertained target movement profile 5b. If the target distance is less than the difference between target position p_{z} and current position in the regulation time step k, the target movement profile 5b is initiated in the current or at latest in the next regulation time step k+1, by which the time for starting the target movement profile 5b is defined. Otherwise, the starting movement profile 5a is continued. This represents an online ascertainment of the target movement profile 5b.

It is therefore also possible that the starting movement phase (pₛ, vₛ, aₛ) and the initial movement phase (p_{A}, v_{A}, a_{A}) coincide.

Of course, it is also possible to ascertain the target movement profile 5b for a specified starting movement profile 5a off-line, thus before the performance of the movement.

If the acceleration in the starting movement profile 5a is equal to zero during a certain time span, thus the velocity cannot change, the target movement profile 5b then only has to be calculated once for this velocity as long as the acceleration remain zero, because the target movement profile 5b cannot change (at least as long as no new target movement phase (pₛ, vₛ, aₛ) is specified).

The starting movement profile 5a could also be planned by means of an acceleration profile while adhering to specified movement limits, wherein the acceleration change between two successive regulation time steps k, k+1 is at most a specified maximum jerk jₘₐₓ, by which the jerk limiting is already implemented. The procedure can be used in this case that velocity changes or position changes are to be implemented as quickly as possible by the starting movement profile 5a. It can therefore again be provided that the accelerations in the acceleration profile of the starting movement profile 5a are to be changed using the specified maximum jerk jₘₐₓ. For movements at constant velocity, the acceleration would simply be set to zero, wherein a previously acting acceleration can only be reduced using the specified maximum jerk. An acceleration change greater than the specified maximum jerk jₘₐₓ is to be suppressed.

One essential advantage in the ascertainment according to the present disclosure of the movement profile 5 or the target movement profile 5b of the movement profile 5 is that no knowledge about the past is required. The storage needed for ascertaining a jerk-limited movement profile 5 is therefore significantly reduced. There are also no dead times as in the case of a jerk filter.

In each regulation time step k, starting from a current movement phase in the regulation time step k as the initial movement phase (p_{A}, v_{A}, a_{A}), a target movement profile 5b can be ascertained. The target distance can be ascertained from the target movement profile 5b. If the target distance is less than the current distance of the moved drive part 3 to the target position p_{z}. (or if the target distance is less than the difference between target position p_{z} and current position), the target movement profile 5b has to be started, by which the time for starting the target movement profile 5b is established. In this case, the target position p_{z} could be exceeded, which can be compensated for, for example, by a compensation of the resulting position error. It would also be conceivable to ascertain the movement phase in the next regulation time step k+1, for example, in that the movement is continued computationally with the maximum jerk jₘₐₓ. The movement phase in the next regulation time step k+1 ascertained computationally could then be used as the initial movement phase (p_{A}, v_{A}, a_{A}) in order to determine a target movement profile 5b and the target distance based thereon. If the determined target distance is less than the current distance of the moved drive part 3 to the target position p_{z} (or if the target distance is less than the difference between target position p_{z} and current position), the ascertained target movement profile 5b is initiated in the current regulation time step k. It is therefore ensured that the moved drive part 3 does not entirely reach the target position p_{z}. However, the resulting position error could be compensated for as described above.

A further advantage can be seen in that the target movement phase (pₛ, vₛ, aₛ) can also be changed during the movement of the drive axle 1. A changed target movement phase (pₛ, vₛ, aₛ) is taken into consideration immediately and without time delay (as would be the case with a jerk filter) in the ascertainment of the target movement profile 5b. It is therefore possible to react flexibly to new specifications of the target movement phase (pₛ, vₛ, aₛ).

Not least, the ascertainment according to the present disclosure of the target movement profile 5b also ensures a linear complexity of the calculation. If the number of the regulation time steps increases, the complexity of the calculation increases linearly with the increase of the number of the regulation time steps. The linear complexity results in particular in that the required calculations are reduced to the ascertainment of areas below a step function and no numerical mathematical methods or optimizations (which are typically solved iteratively) are required.

The movement profile 5, in particular the target movement profile 5b and possibly also the starting movement profile 5a, is specified by a facility controller 6. The facility controller 6 is used to control a facility 10, in which the drive axle 1 is implemented. The movement profile 5 for the drive axle 1 is created on the facility controller 6. The facility controller 6 is a computer having corresponding software for creating the movement profile 5. The drive axle regulator 4 can also be integrated in the facility controller 6.

As mentioned at the outset, the drive axle 1 can be implemented, for example, in a long stator linear motor (also as a planar motor). FIG. 5 shows an example of a long stator linear motor as an embodiment of a facility 10. A long stator linear motor consists of a stator 11, on which magnetic field generating units 12, such as drive coils or movable magnets, are arranged adjacent to one another (only a few of the magnetic field generating units are shown in FIG. 5 for the sake of clarity), which generate a magnetic field. A plurality n of transport units Tn is moved along the stator 11. An excitation magnet arrangement 13, such as permanent magnets, is arranged at each transport unit Tn (the excitation magnet arrangement is only shown at the transport unit T1 in FIG. 5 for the sake of clarity). The magnetic field generated by the magnetic field generating units 12 cooperates with the excitation field generated by the excitation magnet arrangement 13 in order to move the transport unit Tn. A drive axle 1 therefore consists of the magnetic field generating units 12 (or a specific number thereof) as the drive unit 2, which act on a transport unit Tn as the moved drive part 3 in order to move it. Due to the movement, different magnetic field generating units 12 always interact with a transport unit Tn. The magnetic field generating units 12 are actuated by a drive axle regulator 4 by manipulated variables SS to generate a magnetic field, for example, to apply a coil voltage to certain magnetic field generating units 12 in order to generate the magnetic field. The movement manipulated variables BS for the drive axle regulator 4 originate from a movement profile 5 which specifies the movement of the transport unit Tn. In the same way, the drive axle regulator 4 receives actual variables IS of the movement of the transport unit Tn, for example, actual positions at the stator 11 from position sensors (not shown). In this way, the movements of the transport unit Tn on the stator 11 can be planned and carried out individually and independently of one another. In a planar motor, the drive axle 1 forms a movement direction on the stator 11.

Because of the circumstance that the transport units Tn can be moved individually and independently of one another on the stator 11, providing a collision avoidance function is already known. The collision avoidance function is used to prevent an undesired collision between two transport units Tn or between one transport unit Tn and another part of the facility 10, such as a processing station provided on the transport facility. Such a collision avoidance function is disclosed, for example, in EP 3 202 612 A1. In this collision avoidance function, it is continuously checked whether a transport unit Tn can execute a standstill maneuver or alignment maneuver, in which the movement is changed, with specified kinematics without running the risk of colliding with a leading transport unit or with a fixed part of the facility 10. Such a standstill maneuver or alignment maneuver therefore represents a movement profile 5, which can be planned as above, for example. The target movement phase (p_{z}, v_{z}, a_{z}) is given in a standstill maneuver by v_{z}=a_{z}=0. In an alignment maneuver, any target movement phase (p_{z}, v_{z}, a_{z}) can be specified. A standstill maneuver or an equalization alignment is typically to be executed as quickly as possible, thus with the least possible target distance. For this reason, minimal accelerations aₘᵢₙ are also defined as a movement limit for such maneuvers in order to be able to decelerate the transport unit Tn as quickly as possible.

The ascertainment according to the present disclosure of the target movement profile 5b without downstream jerk filter is advantageous in particular for such standstill maneuvers or alignment maneuvers of a collision avoidance function. Above all the circumstance that no dead times occur (as with a jerk filter) in the creation of the target movement profile 5b, enables the required safety distance between adjacent transport units Tn on the stator 11 to be reduced. Transport units Tn can therefore be moved closer to one another, which increases the throughput of transport units Tn per unit of time, which is helpful in particular in transport applications.

In certain applications, multiple transport units Tn also form a transport unit group 14, such as the transport units T1, T2 in FIG. 5, indicated by the dashed line. However, it is not absolutely necessary for the transport units Tn of a transport unit group 14 to be directly adjacent to one another, but rather other transport units can also be moved between them. Of course, it is also advantageous in such a transport unit group 14 if the transport units Tn can move more closely adjacent to one another.

The transport units Tn in a transport unit group 14 move in a coordinated manner with one another, due to which the movements of the transport units Tn in a transport unit group 14 are no longer independent of one another. For example, the distance between two transport units Tn of a transport unit group 14 is to remain constant.

How the movements are coordinated does not play a role in this case. For example, a transport unit Tn in the transport unit group 14 could be used as the master, which specifies a movement which the other transport units Tn in the transport unit group 14 follow.

It is also possible that two transport units Tn in a transport unit group 14 are mechanically coupled, for example, as shown in FIG. 6, for example, by a connection 15 between coupling points 16 on the transport units Tn. The coordinated movement could require in this case, for example, that the distance (for example, the Euclidean distance in space) between the coupling points 16 to remain equal during the movement. The coordinated movement could also require that the force which is exerted by the two transport units Tn via the coupling points 16 on the connection 15 to remain equal.

Movement limits, in particular a maximum acceleration aₘₐₓ and a minimum acceleration aₘᵢₙ, which are to be adhered to, are specified for each transport unit Tn. This does not represent a problem for an independent movement of a transport unit Tn. However, this can result in difficulties due to the coupled movement of transport units Tn in a transport unit group 14, in particular during braking maneuvers, such as a standstill maneuver or alignment maneuver of a collision avoidance function, which are carried out with the maximum possible acceleration, because the coordinated movement has to be maintained at the same time here. Such difficulties often occur in curved sections of the stator 11.

If a transport unit group 14 travels in a curved section of the stator 11, for example, the movements of the transport units Tn in the transport unit group 14 are still coordinated. For example, the distance between two transport units Tn is still maintained. However, it can occur that it is not possible to maintain the coordinated movement using the specified movement limits. For example, the coordinated movement could make it necessary for a transport unit Tn of the transport unit group 14 to have to be decelerated with greater negative acceleration than the minimum acceleration aₘᵢₙ or to have to be accelerated with greater acceleration than the maximum acceleration aₘₐₓ in order to maintain the coordinated movement. However, this is not possible due to the specified movement limits.

To remedy this problem, it is provided that transport units Tn of a transport unit group 14 are assigned second acceleration limits in addition to the defined first acceleration limits. The second acceleration limits are greater in absolute value than the first acceleration limits, thus a negative and/or positive acceleration greater in absolute value than the first acceleration limits. A transport unit Tn in a transport unit group 14 therefore has the possibility of using the second acceleration limits if needed for the movement in order to maintain the coordinated movement of the transport units Tn within the transport unit group 14.

The first acceleration limits and second acceleration limits can be configurable, for example, by a user. However, it is also conceivable that these are set by the drive axle regulator 4 or the facility controller 6, for example, from the knowledge of the application.

For example, a transport unit T1 of a transport unit group 14 performs a breaking maneuver with a specified maximum deceleration according to the specifications of a movement limit having first acceleration limits. Another transport unit T2 of the transport unit group 14 has to follow due to the coordinated movement. If the second transport unit were also only decelerated with the first acceleration limit, it would have more clearance to execute any possible change of the distance between the two transport units T1, T2 at the same time. The second transport unit T2 has this option due to the second acceleration limit, which is greater than the first acceleration limit.

This approach of the second acceleration limit for a transport unit Tn in a transport unit group 14, however, is independent of how the movement profile of the transport unit Tn is planned or created.

An advantageous method can therefore be derived for a long stator linear motor in order to control a transport unit group 14 having multiple transport units Tn, the movements of which are coordinated with one another:

A first acceleration limit is assigned to each of the transport units Tn of the transport unit group 14, by which a maximum possible positive and/or negative first acceleration of the movement of the transport units is established. The transport units Tn of the transport unit group 14 are each assigned a second acceleration limit, using which a maximum possible positive and/or negative second acceleration of the movement of the transport units is established, wherein the positive and/or negative second acceleration is greater in absolute value than the positive and/or negative first acceleration. The transport units Tn in the transport unit group 14 use the first acceleration limit for the movement. If the coordinated movement of the transport units Tn is not thus possible, at least one transport unit Tn of the transport unit group 14 uses the second acceleration limit.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for regulating the movement of a drive axle of a drive, wherein:
the movement of the drive axle is regulated in specified regulation time steps by the specification of a movement setpoint value of the movement, due to which a movement phase of the movement of the drive axle results in each regulation time step,
a target movement phase in the form of a target position, target velocity, and target acceleration is specified for the movement of the drive axle and the target movement phase is set starting from a starting movement phase in the form of a starting position, starting velocity, and starting acceleration by a movement profile while adhering to specified movement limits,
in each regulation time step, the movement setpoint value is obtained from the movement profile,
the movement profile comprises a starting movement profile and a target movement profile,
the starting movement profile starts at the starting movement phase and merges into the target movement profile, which starts in an initial movement phase and ends in the target movement phase,
the target movement profile is ascertained using an acceleration profile over a plurality of regulation time steps,
an acceleration change in each regulation time step corresponds at most to a specified maximum jerk, so that the acceleration profile of the target movement profile is present as a step function in which the acceleration profile is a chronologically discrete sequence of acceleration values at the regulation time steps,
the step function is created while adhering to the specified movement limits, so that the area below the step function corresponds to a velocity change between the initial velocity of the initial movement phase and the target velocity of the target movement phase,
a target distance is ascertained using the ascertained target movement profile, which is covered using the target movement profile, and
a time is ascertained on the basis of the target distance, at which the ascertained target movement profile will be started to reach the target position of the target movement phase.

2. The method as claimed in claim 1, wherein the acceleration in the acceleration profile is reduced or increased starting from the initial acceleration in a first acceleration section in a plurality of regulation time steps by at most the specified maximum jerk and then the acceleration is increased or reduced in a second acceleration section in a plurality of regulation time steps by at most the specified maximum jerk until the target acceleration is reached.

3. The method as claimed in claim 1, wherein the acceleration is reduced or increased starting from the initial acceleration in a first acceleration section in a plurality of regulation time steps by at most the specified maximum jerk until a specified minimum acceleration or maximum acceleration is reached, then the acceleration is kept at the minimum acceleration or maximum acceleration in a third acceleration section for a number of regulation time steps and then the acceleration is increased or reduced in a second acceleration section in a plurality of regulation time steps by at most the specified maximum jerk until the target acceleration is reached.

4. The method as claimed in claim 1, wherein:
an acceleration change in a respective regulation time step of the acceleration profile corresponds to the specified maximum jerk if the specified movement limits permit, so that the area below the step function, except for a residual error, corresponds to the velocity change between the initial velocity of the initial movement phase and the target velocity of the target movement phase,
the acceleration change in at least one regulation time step of the acceleration profile is changed by a jerk value, and
the jerk value is ascertained in order to compensate for the residual error resulting from the step function between the area below the step function and the velocity change.

5. The method as claimed in claim 1, wherein:
a position error resulting from the step function between the target position and a position resulting from the target movement profile is compensated for by changing, in the acceleration profile, the acceleration change at a plurality of regulation time steps in order to lengthen or shorten the target distance by the position error, and
the area below the acceleration profile remains unchanged.

6. The method as claimed in claim 1, wherein, in each regulation time step of the starting movement profile:
the current movement phase is used as the initial movement phase and the target movement profile;
the target distance are ascertained using this initial movement phase; and
the target movement profile is initiated in the next regulation time step if the difference between the target position and the initial position is less than the target distance.

7. The method as claimed in claim 1, wherein, in each regulation time step of the starting movement profile, the movement phase of the next regulation time step following the current regulation time step is used as the initial movement phase; and
the target movement profile and the target distance are ascertained using this initial movement phase and the target movement profile is initiated in the current regulation time step if the difference between the target position and the initial position is less than the target distance.

8. The method as claimed in claim 2, wherein:
an acceleration change in a respective regulation time step of the acceleration profile corresponds to the specified maximum jerk if the specified movement limits permit, so that the area below the step function, except for a residual error, corresponds to the velocity change between the initial velocity of the initial movement phase and the target velocity of the target movement phase,
the acceleration change in at least one regulation time step of the acceleration profile is changed by a jerk value, and
the jerk value is ascertained in order to compensate for the residual error resulting from the step function between the area below the step function and the velocity change.

9. The method as claimed in claim 3, wherein:
an acceleration change in a respective regulation time step of the acceleration profile corresponds to the specified maximum jerk if the specified movement limits permit, so that the area below the step function, except for a residual error, corresponds to the velocity change between the initial velocity of the initial movement phase and the target velocity of the target movement phase,
the acceleration change in at least one regulation time step of the acceleration profile is changed by a jerk value, and
the jerk value is ascertained in order to compensate for the residual error resulting from the step function between the area below the step function and the velocity change.

10. The method as claimed in claim 2, wherein:
a position error resulting from the step function between the target position and a position resulting from the target movement profile is compensated for by changing, in the acceleration profile, the acceleration change at a plurality of regulation time steps in order to lengthen or shorten the target distance by the position error, and
the area below the acceleration profile remains unchanged.

11. The method as claimed in claim 3, wherein:
a position error resulting from the step function between the target position and a position resulting from the target movement profile is compensated for by changing, in the acceleration profile, the acceleration change at a plurality of regulation time steps in order to lengthen or shorten the target distance by the position error, and
the area below the acceleration profile remains unchanged.

12. The method as claimed in claim 4, wherein:
a position error resulting from the step function between the target position and a position resulting from the target movement profile is compensated for by changing, in the acceleration profile, the acceleration change at a plurality of regulation time steps in order to lengthen or shorten the target distance by the position error, and
the area below the acceleration profile remains unchanged.

13. The method as claimed in claim 2, wherein, in each regulation time step of the starting movement profile:
the current movement phase is used as the initial movement phase and the target movement profile;
the target distance are ascertained using this initial movement phase; and
the target movement profile is initiated in the next regulation time step if the difference between the target position and the initial position is less than the target distance.

14. The method as claimed in claim 3 wherein, in each regulation time step of the starting movement profile:
the current movement phase is used as the initial movement phase and the target movement profile;
the target distance are ascertained using this initial movement phase; and
the target movement profile is initiated in the next regulation time step if the difference between the target position and the initial position is less than the target distance.

15. The method as claimed in claim 4 wherein, in each regulation time step of the starting movement profile:
the current movement phase is used as the initial movement phase and the target movement profile;
the target distance are ascertained using this initial movement phase; and
the target movement profile is initiated in the next regulation time step if the difference between the target position and the initial position is less than the target distance.

16. The method as claimed in claim 5, wherein, in each regulation time step of the starting movement profile:
the current movement phase is used as the initial movement phase and the target movement profile;
the target distance are ascertained using this initial movement phase; and
the target movement profile is initiated in the next regulation time step if the difference between the target position and the initial position is less than the target distance.

17. The method as claimed in claim 2, wherein, in each regulation time step of the starting movement profile, the movement phase of the next regulation time step following the current regulation time step is used as the initial movement phase; and
the target movement profile and the target distance are ascertained using this initial movement phase and the target movement profile-is initiated in the current regulation time step if the difference between the target position and the initial position is less than the target distance.

18. The method as claimed in claim 3, wherein, in each regulation time step of the starting movement profile, the movement phase of the next regulation time step following the current regulation time step is used as the initial movement phase; and
the target movement profile and the target distance are ascertained using this initial movement phase and the target movement profile-is initiated in the current regulation time step if the difference between the target position and the initial position is less than the target distance.

19. The method as claimed in claim 4, wherein, in each regulation time step of the starting movement profile, the movement phase of the next regulation time step following the current regulation time step is used as the initial movement phase; and
the target movement profile and the target distance are ascertained using this initial movement phase and the target movement profile-is initiated in the current regulation time step if the difference between the target position and the initial position is less than the target distance.

20. The method as claimed in claim 5, wherein, in each regulation time step of the starting movement profile, the movement phase of the next regulation time step following the current regulation time step is used as the initial movement phase; and
the target movement profile and the target distance are ascertained using this initial movement phase and the target movement profile-is initiated in the current regulation time step if the difference between the target position and the initial position is less than the target distance.
